(19) United States
(12) Patent Application Publication
(10) Pub. No.: US 2009/0323221 A1
(43) Pub. Date: Dec. 31, 2009

(54) HEAD STACK ASSEMBLY AND DISK DRIVE UNIT PROVIDED WITH THE SAME

(75) Inventor: Hirofumi Kuribara, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/474,190

(22) Filed: May 28, 2009

(30) Foreign Application Priority Data
Jun. 30, 2008 (JP) 2008-170434

(51) Int. Cl. G11B 5/48

(52) U.S. Cl. 360/240; G9B/5.147

(57) ABSTRACT

According to one embodiment, a head stack assembly includes stack members stacked on a bearing unit, a suspension and a head on one of the stack members, and an elastic member being between the stack members to damp vibration when there is the vibration which is transmitted from the bearing unit to the stack members.

### CROSS-REFERENCE TO RELATED APPLICATIONS

This application is based upon and claims the benefit of priority from Japanese Patent Application No. 2008-170434, filed Jun. 30, 2008, the entire contents of which are incorporated herein by reference.

### BACKGROUND

1. Field

An embodiment of the invention relates to a head stack assembly used in a disk drive unit provided with a disk recording medium and a disk drive unit provided with the same.

2. Description of the Related Art

In recent years, disk drive units, such as magnetic disk devices, optical disc devices, etc., have been widely used as external recording devices of computers or image recording apparatuses.

A magnetic disk device, e.g., a hard disk drive (HDD), is generally provided with a magnetic disk or disks, spindle motor, magnetic heads, head stack assembly, voice coil motor, board unit, etc. The spindle motor rotates the magnetic disk. The magnetic head reads and writes data from and to the disk. The head stack assembly supports the head. The voice coil motor drives the head stack assembly. These elements are contained in a substantially sealed housing.

As disclosed in Jpn. Pat. Appln. KOKAI Publication No. 5-151724, for example, a head stack assembly is provided with a bearing unit, head gimbal assemblies (HGAs) laminated to the bearing unit, coil assembly, spacer, washer, nut, etc. Each HGA includes an arm extending from the bearing unit, a suspension extending from the arm, and a head attached to the suspension by means of a gimbal portion. A plurality of arms are fixed in layers to the bearing unit with spacers between them. The coil assembly is provided with a support frame that extends from the bearing unit oppositely from the HGAs and supports a coil of a voice coil motor.

Each magnetic disk is provided with two HGAs for its obverse and reverse surfaces. In a disk drive unit that uses two magnetic disks, for example, a head stack assembly is composed of four HGAs that are stacked in layers on a bearing unit with spacers between them.

If the voice coil motor is driven, the head stack assembly rocks around the bearing unit, whereupon the magnetic head is moved to and positioned in a region over a desired track of the magnetic disk.

In the head stack assembly constructed in this manner, the individual components are stacked around the bearing unit, and their respective metal parts directly contact one another. Therefore, if the bearing unit vibrates along its axis, for example, this vibration is transmitted in succession from the bearing unit to the arm, spacer, and suspension. Alternatively, the vibration of the bearing unit is transmitted to the nut, washer, arm, coil assembly, and suspension in the order named. Thus, vibrations of the individual components that constitute the head stack assembly are transferred between the components, so that the entire head stack assembly vibrates. If the vibration is transmitted to the suspension, the positioning accuracy of the magnetic heads is reduced, thereby causing problems such as reduction in read/write performance, occurrence of write errors, etc.

If the bearing unit is subjected to a heavy impact through the housing, moreover, the impact may be transmitted to the suspension and the magnetic heads, thereby damaging the head stack assembly and the magnetic disks.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary exploded perspective view showing an HDD according to a first embodiment of the invention with its top cover off;

FIG. 2 is an exemplary perspective view showing a head stack assembly of the HDD;

FIG. 3 is an exemplary exploded perspective view of the head stack assembly;

FIG. 4 is an exemplary enlarged, cutaway, exploded perspective view showing a part of the head stack assembly;

FIG. 5 is an exemplary sectional view showing a bearing unit portion of the head stack assembly;

FIG. 6 is an exemplary sectional view showing a bearing unit portion of a stack assembly of an HDD according to a second embodiment of the invention; and

FIG. 7 is an exemplary enlarged sectional view showing a part of the stack assembly of the second embodiment.

### DETAILED DESCRIPTION

Various embodiments according to the invention will be described hereinafter with reference to the accompanying drawings. In general, according to one embodiment of the invention, a head stack assembly comprises stack members stacked on a bearing unit; a suspension and a head on one of the stack members; and an elastic member being between the stack members to damp vibration when there is the vibration which is transmitted from the bearing unit to the stack members.

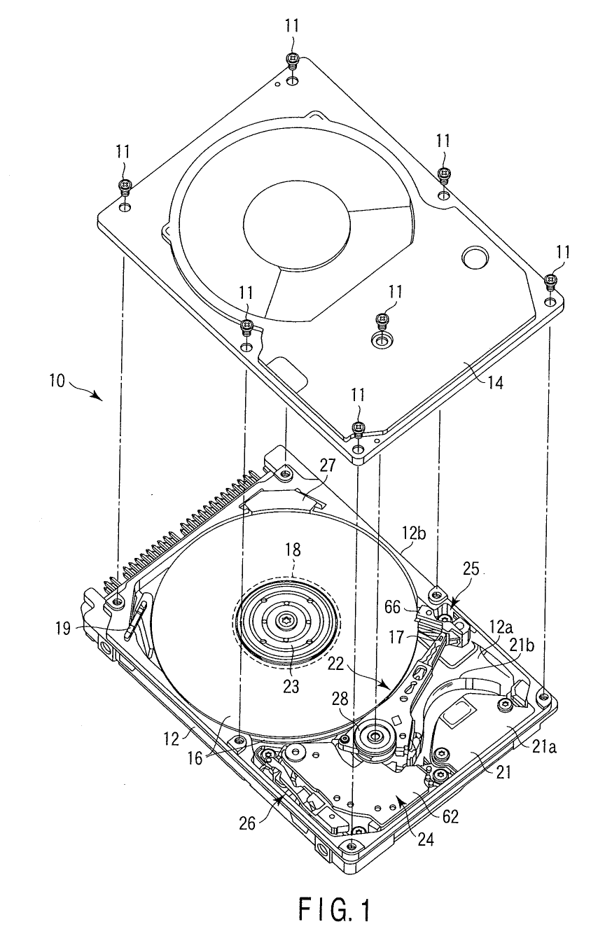

An HDD according to a first embodiment of this invention will now be described in detail with reference to the accompanying drawings. FIG. 1 shows the internal structure of the HDD with its top cover off. As shown in FIG. 1, the HDD is provided with a housing 10. The housing 10 includes a base 12 in the form of an open-topped rectangular box and a top cover 14, which is fastened to the base by screws 11 so as to close the top opening of the base. The base 12 includes a rectangular bottom wall 12a and a sidewall 12b set up along the peripheral edge of the bottom wall.

The housing 10 contains two magnetic disks 16 for use as recording media and a spindle motor 18 as a drive section that supports and rotates the magnetic disks. The spindle motor 18 is located on the bottom wall 12a. The housing 10 is formed to be large enough to accommodate a plurality of, e.g., two, magnetic disks, and the spindle motor 18 is configured to support and drive two magnetic disks.

Each magnetic disk 16 is formed with a diameter of, for example, 65 mm (2.5 inches) and has magnetic recording layers on its upper and lower surfaces, individually. The disks 16 are coaxially fitted on a hub (not shown) of the spindle motor 18 and clamped and fixed on the hub by a clamp spring 23. Thus, the disks 16 are supported parallel to the bottom wall 12a of the base 12. The disks 16 are rotated at a predetermined speed of, for example, 5,400 or 7,200 rpm by the spindle motor 18.

The housing 10 further contains magnetic heads 17, head stack assembly (HSA) 22, voice coil motor (VCM) 24, ramp load mechanism 25, latch mechanism 26, and board unit 21. The magnetic heads 17 record and reproduce information on and from the magnetic disks 16. The HSA 22 supports the heads 17 for movement with respect to the disks 16. The VCM 24 rocks and positions the HSA 22. The ramp load mechanism 25 holds the magnetic heads in a retracted position at a distance from the magnetic disks when the heads are moved to the outermost peripheries of the disks. The latch mechanism 26 holds the HSA in its retracted position when the HDD is jolted. The board unit 21 includes a preamplifier and the like.

A printed circuit board (not shown) is screwed to the outer surface of the bottom wall 12a of the base 12. The circuit board controls the operations of the spindle motor 18, VCM 24, and magnetic heads through the board unit 21. A circulation filter 19 is disposed on the sidewall of the base 12 and situated outside the magnetic disks 16. The filter 19 captures dust that is produced in the housing when a moving part is operated. Further, a breathing filter 27 is disposed on the sidewall of the base 12. The filter 27 captures dust from air that flows into the housing 10.

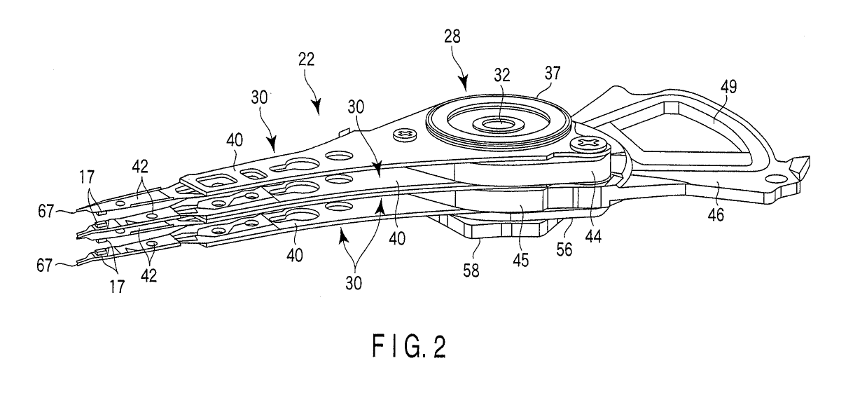

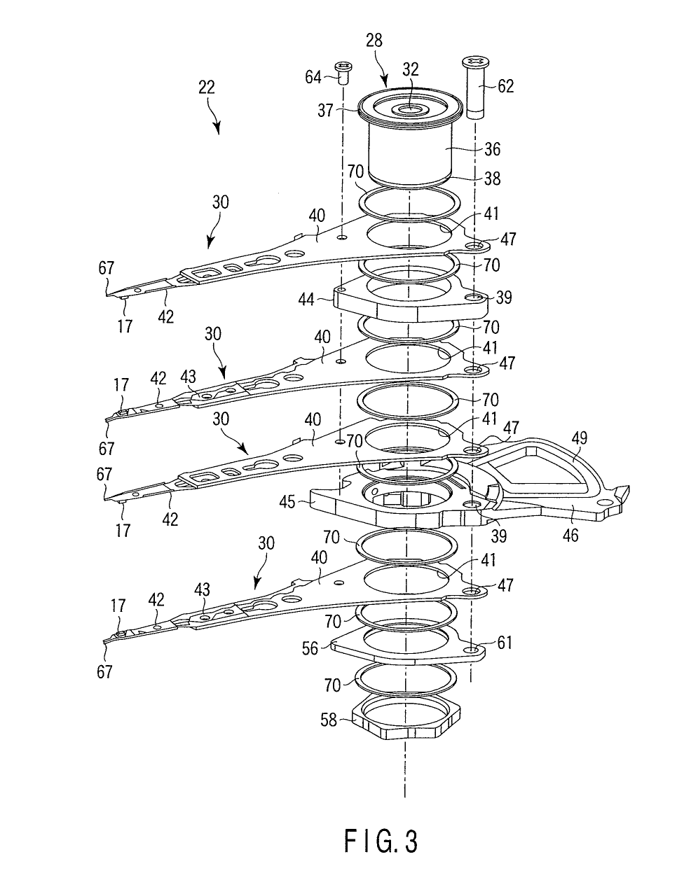

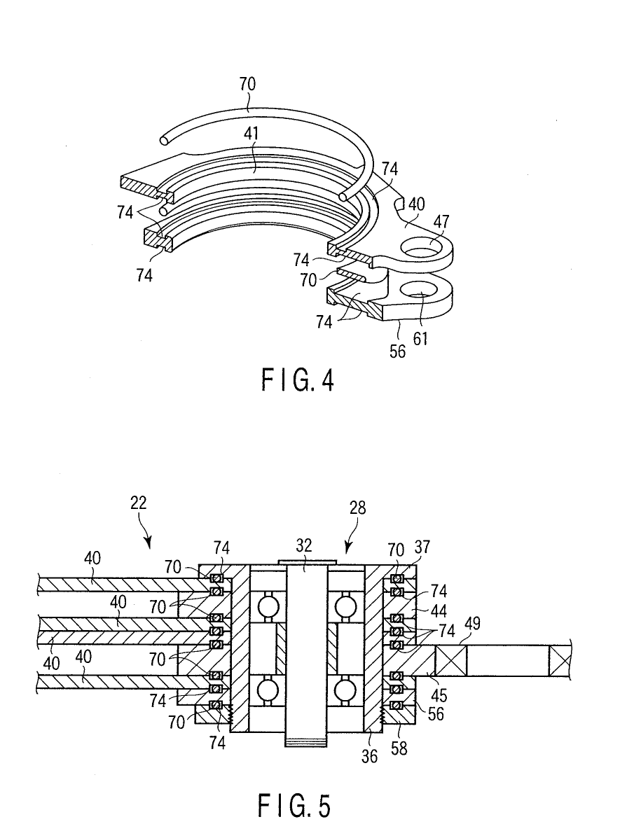

FIG. 2 is a perspective view showing the HSA 22, and FIG. 3 is an exploded perspective view of the HSA. Further, FIG. 4 is an enlarged, cutaway perspective view showing some stack members that constitute the HSA, and FIG. 5 is a sectional view showing a bearing unit portion of the HSA. As shown in FIGS. 1 to 5, the HSA 22 is provided with a rotary bearing unit 28 and a plurality of stack members that are laminated to one another on the bearing unit 28. In the present embodiment, the stack members include four head gimbal assemblies (HGAs) 30, two spacer rings 44 and 45 laminated between the HGAs, an annular washer 56, and a nut 58.

The bearing unit 28 is situated apart from the center of rotation of each magnetic disk 16 along the length of the base 12 and near the outer peripheral edge of the disk. The bearing unit 28 includes a pivot 32 set up on the bottom wall 12a of the base 12 and a cylindrical sleeve 36 coaxially supported for rotation on the pivot by a bearing 34. An annular flange 37 is formed on the upper end of the sleeve 36 that functions as a bearing body, while a thread portion 38 is formed on the outer periphery of its lower end portion.

Each HGA 30 includes an arm 40 extending from the bearing unit 28, a suspension 42 extending from the arm, and the magnetic head 17 supported on an extended end of the suspension by a gimbal portion.

The arm 40 is a thin flat plate formed by laminating, for example, stainless steel, aluminum, and stainless steel layers to one another. A circular through-hole 41 is formed in one end or a proximal end of the arm 40. Further, the arm 40 has a lug protruding from its proximal end, and a positioning hole 47 is formed in the lug. The suspension 42 is formed of an elongated leaf spring, and its proximal end is fixed to the distal end of the arm 40 by spot welding or adhesive bonding and extends from the arm. The suspension 42 and the arm 40 may be formed integrally of the same material.

Each magnetic head 17 includes a substantially rectangular slider and a magnetoresistive (MR) read/write head formed on the slider and is fixed to the gimbal portion formed on the distal end portion of the suspension 42. Further, the magnetic head 17 includes four electrodes (not shown). A relay flexible printed circuit board (FPC) 43 is set on the arm 40 and the suspension 42. The magnetic head 17 is electrically connected to a main FPC 21b (mentioned later) through the relay FPC.

The spacer rings 44 and 45 are each provided with a through-hole through which the sleeve 36 of the bearing unit 28 can be passed. The rings 44 and 45 are formed of aluminum or the like and each have a predetermined thickness and a predetermined outside diameter. Each of the spacer rings 44 and 45 includes a lug on the outside, and a positioning hole 39 is formed in the lug. A plastic support frame 46 is molded integrally with the one spacer ring 45 so as to extend outward from the ring 45. A voice coil 49 of the VCM 24 is fixed to the support frame 46.

The annular washer 56 has a through-hole through which the sleeve 36 of the bearing unit 28 can be passed. The washer 56 is formed of aluminum or the like and has a predetermined thickness and a predetermined outside diameter. The washer 56 includes a lug on the outside, and a positioning hole 61 is formed in the lug.

The four HGAs 30 and the two spacer rings 44 and 45 are fitted on the sleeve 36 of the bearing unit 28 that is passed through the respective through-holes of the spacer rings 44 and 45, and are stacked in layers on the flange 37 along the axis of the sleeve. The spacer rings 44 and 45 are fitted on the sleeve 36 in such a manner that they are sandwiched between the two adjacent upper arms 40 and between the two adjacent lower arms 40, respectively. Further, the annular washer 56 is fitted on the lower end portion of the sleeve 36.

The four arms 40, spacer rings 44 and 45, and washer 56 that are fitted on the sleeve 36 are sandwiched between the flange 37 and the nut 58, which is threadedly fitted on the thread portion 38 of the sleeve 36, and are fixedly held on the outer periphery of the sleeve.

A positioning screw 62 is passed through the respective positioning holes 47 of the four arms 40 and the respective positioning holes 39 of the spacer rings 44 and 45 and screwed into the positioning hole 61 of the washer 56 from above. Further, a positioning screw 64 is passed through the four arms 40 and the spacer ring 44 and screwed into the spacer ring 45. Thus, the four arms 40 and the spacer rings 44 and 45 are positioned relatively to one another with respect to the circumference of the sleeve 36.

The four arms 40 extend in the same direction from the sleeve 36, and the arms 40 and the suspensions 42 are rockable integrally with the sleeve 36. The two upper arms 40 are situated parallel to each other across a predetermined space, and the suspensions 42 and the magnetic heads 17 on the arms are opposed to one another. The support frame 46 that is integral with the spacer ring 45 extends from the bearing unit 28 oppositely from the arms 40.

As shown in FIGS. 3 to 5, the HSA 22 is provided with a plurality of elastic members 70 that are sandwiched between the adjacent stack members along the axis of the bearing unit 28. Each elastic member 70 is formed of, for example, an elastic material having a vibration-damping effect, e.g., a synthetic resin that undergoes little thermal deformation and outgases little. Each elastic member 70 is, for example, annular.

On the outer peripheral side of the sleeve 36, the elastic members 70 are arranged individually between the flange 37 of the sleeve 36 and the uppermost arm 40, between the spacer ring 44 and the arms on the opposite sides thereof, between the two middle arms, between the spacer ring 45 and the arms on the opposite sides thereof, between the lowermost arm and the washer 56, and between the washer and the nut 58.

Further, the stack members are laminated along the axis of the bearing unit 28 in such a manner that their respective metal surfaces are in contact with those of their adjacent stack members. In the present embodiment, the contact surface of each stack member is formed with a substantially annular receiving groove 74 around the bearing unit 28. Each elastic member 70 is located between each two adjacent stack members in such a manner that it is received in the respective receiving grooves 74 of the stack members.

As shown in FIGS. 4 and 5, the annular receiving groove 74 is formed in, for example, each surface of the washer 56 and situated around a through-hole. Further, the annular receiving groove 74 is formed in each surface of the proximal end portion of each arm 40 and situated around the through-hole 41. In a laminated state, the upper surface of the washer 56 and the lower surface of its adjacent arm 40 are in surface contact with each other so that the respective receiving grooves 74 of the two members face each other and individually define annular receiving spaces that communicate with each other. The elastic member 70 is received in the respective receiving grooves 74 of the washer 56 and the arm 40 so as to contact the washer 56 and the arm 40. Thus, the elastic members 70 that are sandwiched between the stack members having the receiving grooves 74 can damp the vibration of the HSA 22 while maintaining the height accuracy of the stacks on the metallic contact surfaces of the stack members.

When the HSA 22 constructed in this manner is incorporated in the base 12, as clearly shown in FIG. 1, the lower end portion of the pivot 32 of the bearing unit 28 is fixed to the base 12 and set up substantially parallel to the spindle of the spindle motor 18. Each magnetic disk 16 is situated between the corresponding two adjacent HGAs 30. While the HDD is operating, the magnetic heads 17 that are attached individually to the arms 40 face the upper and lower surfaces, individually, of the disk 16 and hold the disk from both sides. The voice coil 49 that is fixed to the support frame 46 is situated between a pair of yokes 62 that are fixed on the base 12. The coil 49, along with these yokes and a magnet (not shown) fixed to one of the yokes, constitutes the VCM 24.

As shown in FIG. 1, the board unit 21 includes a body 21a that is formed of a flexible printed circuit board. The body 21a is fixed to the bottom wall 12a of the base 12. An electronic component, such as a head amplifier, is mounted on the body 21a. The board unit 21 includes the main flexible printed circuit board (main FPC) 21b that extends from the body 21a. An extended end of the main FPC 21b is connected to the vicinity of the bearing unit 28 of the HSA 22 and also electrically connected to the magnetic heads 17 through the relay FPCs 43 on the arms 40 and the suspensions 42. A connector (not shown) for connection with the printed circuit board is mounted on the bottom surface of the body of the board unit 21.

The ramp load mechanism 25 includes a ramp 66 and tabs 67. The ramp 66 is provided on the bottom wall 12a of the base 12 and located outside the magnetic disks 16. The tabs 67 extend individually from the respective distal ends of the suspensions 42. As the HSA 22 turns around the bearing unit 28 so that each magnetic head 17 is moved to its retracted position outside the magnetic disks 16, each tab 67 engages with a ramp surface formed on the ramp 66 and is then pulled up along the slope of the ramp surface. Thereupon, the magnetic heads 17 are unloaded from the magnetic disks 16 and held in the retracted position.

According to the HDD constructed in this manner, each magnetic disk 16 is rotated at high speed during operation. If the voice coil 49 is energized, the HSA 22 rocks around the bearing unit 28, whereupon each magnetic head 17 is moved to and positioned in a region over a desired track of the magnetic disk 16. Thus, the head 17 can perform information processing, that is, write or read information to or from the disk 16.

According to the HDD described above, the HSA 22 is provided with the elastic members 70 that are sandwiched between the adjacent stack members. If the base 12 or the bearing unit 28 is vibrated, therefore, the elastic members 70 between the stack members can damp vibration transmitted from the bearing unit to the stack members. According to the present embodiment, the elastic members 70 are arranged individually between the flange 37 of the sleeve 36 and the uppermost arm 40, between the spacer ring 44 and the arms on the opposite sides thereof, between the two middle arms, between the spacer ring 45 and the arms on the opposite sides thereof, between the lowermost arm and the washer 56, and between the washer and the nut 58. As the vibration is transmitted, therefore, it is gradually damped by means of the elastic members 70. Thus, the vibration transmitted to the suspensions 42 and the magnetic heads 17 is reduced. In consequence, the head positioning accuracy can be improved, so that the read/write performance during the application of vibration can be enhanced, and a reduction in the incidence of write errors can be expected. As the positioning accuracy for the magnetic heads is improved, moreover, the recording capacity of the magnetic disks can be increased.

Also if impact, not vibration, is applied to the base 12 and the bearing unit 28, the elastic members 70 can reduce the impact peak in the same manner as aforesaid. In consequence, the members can be prevented from being damaged.

Further, the stack members are laminated with their respective metal surfaces in contact with one another, and the elastic members are located in the receiving grooves of the stack members. Therefore, a vibration-damping effect can be obtained while maintaining the stack height of the HSA 22 with high accuracy.

Thus, there can be obtained a head stack assembly, capable of damping or reducing vibration and impact and improving head positioning accuracy and reliability, and a disk drive unit provided with the same.

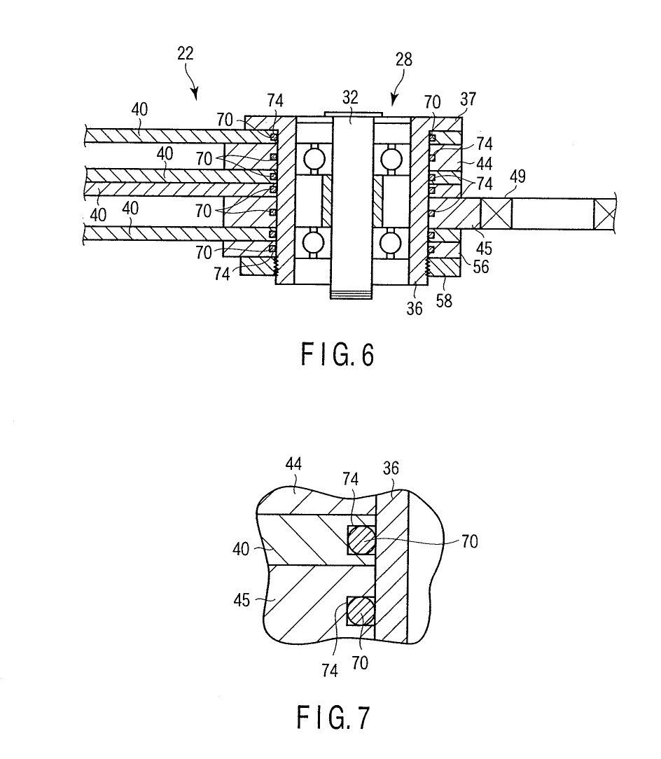

The following is a description of an HSA 22 of an HDD according to a second embodiment of this invention. FIG. 6 is a sectional view showing a bearing unit portion of the HSA, and FIG. 7 is an enlarged sectional view showing a part of the HSA. According to the second embodiment, as shown in FIG. 6, elastic members 70 are provided between a bearing unit and stack members that constitute the HSA and serve to damp vibration that is radially transmitted from the bearing unit.

More specifically, a plurality of stack members, including four arms 40, spacer rings 44 and 45, a washer 56, and a nut 58, are fitted in layers on a sleeve 36 of a bearing unit 28. As shown in FIGS. 6 and 7, annular receiving grooves 74 are formed individually in the respective inner peripheral surfaces of through-holes 41 of the arms 40, bores of the spacer rings 44 and 45, and a through-hole of the washer 56. The annular elastic members 70 are interposed between the sleeve 36 and the stack members in such a manner that they are received in the receiving grooves 74.

Other configurations of the HSA 22 and the HDD of the second embodiment are the same as those of the foregoing first embodiment, so that a detailed description thereof is omitted.

According to the second embodiment constructed in this manner, the elastic members that are provided between the bearing unit 28 and the stack members can damp vibration transmitted radially from the bearing unit to the stack members. Thus, the vibration transmitted to suspensions 42 and magnetic heads 17 is reduced. In consequence, the head positioning accuracy can be improved, so that the read/write performance during the application of vibration can be enhanced, and a reduction in the incidence of write errors can be expected. As the positioning accuracy for the magnetic heads is improved, moreover, the recording capacity of magnetic disks can be increased. Further, the same functions and effects as those of the first embodiment can be obtained.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

In the foregoing first embodiment, for example, the HSA is configured so that the elastic members are provided between all the adjacent stack members. However, a vibration-damping effect can be obtained if an elastic member is sandwiched between at least a pair of adjacent stack members. Further, a plurality of elastic members, instead of one, may be provided between each two adjacent stack members. In the second embodiment, the HSA is configured so that the elastic members are provided individually between the bearing unit and all the stack members except the nut. However, a vibration-damping effect can be obtained if an elastic member is sandwiched between at least one stack member and the bearing unit. Each elastic member is not limited to the annular shape and may be of, for example, a split shape.

In the embodiments described above, the receiving grooves are formed individually in the respective contact surfaces of each two adjacent stack members. Alternatively, however, a receiving groove may be formed in at least one of the contact surfaces so that an elastic member is received in the groove. Further, the receiving grooves may be omitted so that elastic members are located directly between the contact surfaces of stack members.

Although the disk drive that can be loaded with two magnetic disks has been described in connection with each of the foregoing embodiments, the present invention is also applicable to a disk drive that is provided with one or three or more magnetic disks and a head stack assembly therefor. Further, the materials of the components of the HSA can be variously selected without being limited to the embodiments described herein.

What is claimed is:

1. A head stack assembly comprising:
stacked components on a bearing;
a suspension and a head supported on one of the stacked components; and
an elastic component between the stack members configured to damp vibration from the bearing to the stacked components.

2. The head stack assembly of claim 1, wherein the stacked components comprises an arm, a spacer, and a washer.

3. The head stack assembly of claim 2, wherein the suspension and the head are on the arm.

4. The head stack assembly of claim 1, wherein the bearing comprises a tubular bearing body, and the stacked components are on the outer side of the bearing body.

5. The head stack assembly of claim 4, further comprising through-holes comprising the bearing body in the through-holes.

6. The head stack assembly of claim 4, wherein the elastic component is annular between the stacked components on the outer side of the bearing body.

7. The head stack assembly of claim 4, the stacked components comprises grooves on the outer side of the bearing body.

8. The head stack assembly of claim 7, the elastic component is in the groove and between the stacked components.

9. A head stack assembly comprising:
stacked components on a bearing;
a suspension and a head on one of the stacked components; and
an elastic component between one of the stacked components and the bearing, the elastic component being configured to damp vibration from the bearing to the stacked components.

10. The head stack assembly of claim 9, wherein the stacked components comprises an arm, a spacer and a washer.

11. The head stack assembly of claim 10, wherein the suspension and the head are on the arm.

12. The head stack assembly of claim 9, wherein the bearing comprises a tubular bearing body, and the stacked components are on the bearing body.

13. The head stack assembly of claim 12, further comprising through-holes comprising the bearing in the through-holes.

14. The head stack assembly of claim 12, wherein the elastic component is annular between the bearing body and at least one of the stacked components.

15. The head stack assembly of claim 9, wherein the stacked components comprises grooves in inner surfaces of the stacked components, and the elastic component is in the grooves and between the bearing body and each of the stacked components.

16. A disk drive apparatus comprising:
a disk recording medium; and
a head stack assembly comprising stacked components on a bearing; a suspension and a head on one of the stacked components; and
an elastic component between the stacked components configured to damp vibration from the bearing to the stacked components.
